(19) United States
(12) Patent Application Publication
(10) Pub. No.: US 2007/0153845 A1
(43) Pub. Date: Jul. 5, 2007

(54) WIDE-BAND TUNABLE LASER

(75) Inventors: PIETRO BERNASCONI, EATONTOWN, NJ (US); CHRISTOPHER R. DOERR, MIDDLETOWN, NJ (US); DAVID NEILSON, OLD BRIDGE, NJ (US); JOHN SIMSARIAN, CRANFORD, NJ (US)

Correspondence Address: BROSEMER, KOLEFAS & ASSOCIATES, LLC - (LUCENT), 1 BETHANY ROAD, BUILDING 4 - SUITE # 58, HAZLET, NJ, 07730, US

(73) Assignee: LUCENT TECHNOLOGIES INC., MURRAY HILL, NJ (US)

(21) Appl. No.: 11/306,541

(22) Filed: Dec. 31, 2005

(51) Int. Cl. H01S 3/098; H01S 3/10; H01S 3/13

(52) U.S. Cl. 372/32; 372/20; 372/18

(57) ABSTRACT

A tunable laser module having two or more tunable lasers exhibiting different, possibly contiguous or partially overlapping wavelength regions. The lasers are integrated into a single package, thereby extending a total wavelength range for the package that is substantially beyond that covered by a single laser while—at the same time—providing gap-free wavelength range coverage. Of further advantage, the laser module employs a locking mechanism that is relatively immune from backscatter.

### FIELD OF THE INVENTION

This invention relates generally to the field of tunable semiconductor lasers, and in particular to a wide-band tunable laser module having two or more tunable lasers.

### BACKGROUND OF THE INVENTION

Tunable semiconductor lasers play a critical role in high capacity, dense wavelength division multiplexed (DWDM) transmission systems that form the backbone of today's optical communications networks. In addition, they are generally regarded as being the preferred transmitters for future optical systems.

### SUMMARY OF THE INVENTION

We have developed, in accordance with the principles of the invention, a tunable laser module having two or more tunable lasers exhibiting different, possibly contiguous or partially overlapping wavelength regions. The lasers are integrated into a single package, thereby extending a total wavelength range for the package that is substantially beyond that covered by a single laser. Advantageously, our laser module may provide the total wavelength range without any gaps.

### BRIEF DESCRIPTION OF THE DRAWING

A more complete understanding of the present invention may be realized by reference to the accompanying drawing in which:

FIG. 1 is a schematic block diagram of a hybrid packaging of a commercially available laser module illustrative of the Prior Art;

FIG. 2 is a schematic block diagram of a first embodiment of a wide-band tunable laser package according to the present invention;

FIG. 3 is a schematic block diagram of an alternative embodiment of a wide band tunable laser package according to the present invention;

FIG. 4 is a schematic block diagram of a wide-band tunable laser package according to the present invention illustrating lock sharing;

FIG. 5(a) is a schematic block diagram of an additional alternative embodiment of a wideband tunable laser package according to the present invention illustrating driving circuitry sharing;

FIG. 5(b) is a schematic block diagram of an additional alternative embodiment of the wideband tunable laser package of FIG. 5(a) illustrating an off-axis wavelength locking arrangement thereby eliminating problems associated with back-reflections; and

FIG. 6 is a block diagram of a frequency locking mechanism according to the present invention.

### DETAILED DESCRIPTION

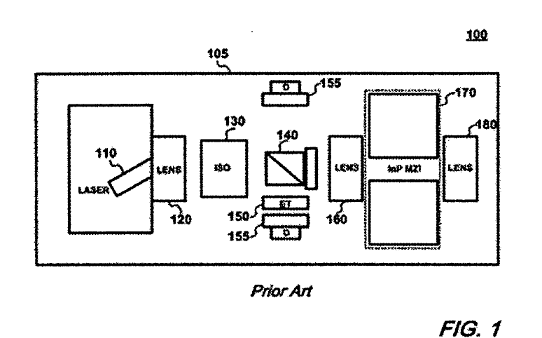

For long haul telecommunications applications wide-band tunable laser modules employing a distributed feedback laser (DFB) have found wide application. An example of such a module is shown in FIG. 1.

With reference to that FIG. 1, shown there is a laser module 100 including DFB or DBR-type laser chip 110 and Indium Phosphide (InP) Mach-Zehnder modulator 170 co-packaged within a single package 105. The coupling between the laser 110 and the modulator 170 is via free-space optics. More specifically, lenses 120, 160, Isolator 130 and wavelength locking arrangement 140 comprise the free space optics.

Shown further in the laser module 100 are two photodiode detectors 155 and etalon 150 which are part of a typical wavelength locking mechanism. In operation, one of the photodiode detectors 155 will serve as a reference photodiode to produce a photocurrent proportional to the laser chip facet power. The second photodiode detector is an Etalon photodiode and produces a photocurrent related to wavelength (frequency).

Co-packaging the laser 110, wavelength locking arrangement 140, modulator 170, and associated components (Power Monitor, Variable Optical Attenuators (VOA), and temperature control circuitry) provide significant opportunity for cost reduction. Despite such advantages however, prior art laser modules 100 only include a single laser and therefore provide only a limited emission range covering, for example, only the C or L band necessary for present day transmission systems.

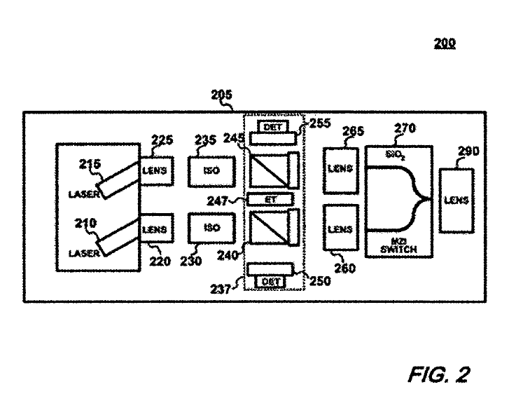

FIG. 2 shows a laser module 200 according to the present invention in which the co-packaging advantageously includes both C-band and L-band laser chips 210, 215 a number co-packaged within a single package 205. Laser light output from the laser chips 210, 215, is combined through the effect of a solid-state integrated chip 270 (i.e., silica) including a combiner or a switch such that the signals output from the laser(s) are combined into a single signal.

As shown in this FIG. 2, the integrated combiner/switching chip 270 is optically interconnected with the lasers 210, 215 via free-space optics including lenses 220, 225, isolators 203, 235, wavelength locking arrangement 237, and additional lenses 260, 265, respectively. As shown in this FIG. 2, the wavelength locking arrangement 237 preferably includes a pair of photodiode detectors 250, 255, and etalon 247. Output lens 290 operates on combined signal(s) output from integrated combiner/switching chip 270.

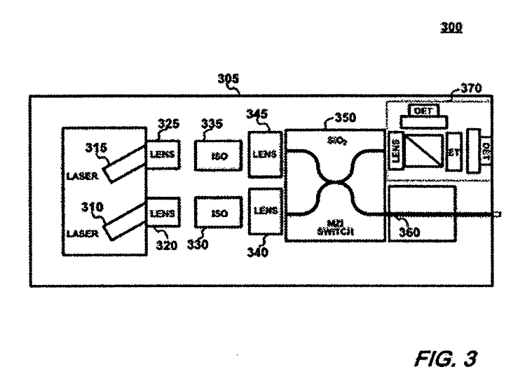

As can be readily appreciated by those skilled in the art, our inventive structure(s) depicted in this FIG. 3 permit the sharing of the wavelength locking arrangement 237 between the two lasers 210, 215. Other circuitry (i.e., driving circuitry, etc) may be shared as well.

Of further significance, such a laser module 200 will advantageously offer a much broader output spectrum than is possible with only a single laser chip. In this example, the module 200, may be tuned to provide wavelengths throughout the C-band and L-band(s) (and/or others)—in sharp contrast to the Prior Art. Additionally, and as a further function of its flexability, such a wide-band module may provide it output without any wavelength gaps, thereby minimizing the number of distinct modules that must be employed for a particular application resulting in significant inventory reductions.

While we have only explicitly discussed providing the wavelengths throughout the C-band and L-band(s), it is important to note that our invention is not so limited. More specifically, other bands, (i.e., S-Band) or combinations thereof are certainly possible and contemplated with our inventive teachings.

Still further, it is important to appreciate that our inventive module(s) are not limited to only two laser chips such as those shown in FIG. 2. Three, four, or more individual laser(s) may be advantageously integrated into the same package. Of course, the included individual lasers need not operate over the same wavelength(s).

At this point it is notable that when one passively combines lasers there is associated with such combining a loss, i.e., 3 dB. While this may not be significant when considering only 2 lasers, a 6 dB loss associated with the combination of 4 lasers may be unacceptable. Advantageously—and according to the present invention—when these multiple lasers are combined using an active switch (such as the integrated Mach-Zehnder disclosed herein) the losses are substantially eliminated.

Of particular advantage, by packaging two or more tunable lasers with different, possibly overlapping wavelength regions into a single package—according to the present invention—the overall total wavelength range is extended beyond that possible with a single laser. In addition, the multiple lasers may share optical elements, driving circuitry and control electronics.

Of still further advantage is that a module constructed according to our inventive teachings permits the independent manufacture of relatively narrower-band tunable lasers—which are easier to manufacture—and combine them into a wide-band tunable laser. As can be appreciated, no moving parts are necessary thereby increasing the reliability and manufacturability of our inventive device(s).

FIG. 3 shows another alternative embodiment of a laser module 300 constructed according to our inventive teachings. In particular, two lasers, i.e., a C-Band laser and a L-Band laser 315, 310 are co-packaged in single package 305. In this configuration, it will be understood that the two lasers may advantageously share any driving electrical circuitry (not specifically shown). A solid state integrated chip 350, including a combiner and/or a switch is used to combine to signals from the two lasers 310, 315, into a single output. In this configuration, the wavelength locking arrangement 370 is shared by the two lasers 310, 315 and is optically connected to the lasers via an output of the combiner/switch 350 as shown. Similarly, light output from the laser(s) is directed into polarization maintaining (PM) fiber 360 through which it is subsequently output.

Shown in this FIG. 3 is a particularly important aspect of our inventive structure(s)—that is the locking arrangement is isolated from any back-reflections that may occur from the output fiber coupling and/or output lenses. As can be readily appreciated from inspecting the structure depicted in FIG. 3, the wavelength locking arrangement 370 is “off-axis” or not directly in the optical path of output laser light. As a result, the locking arrangement 370 is effectively “isolated” from any back-reflections and does not contribute any loss to light that is output.

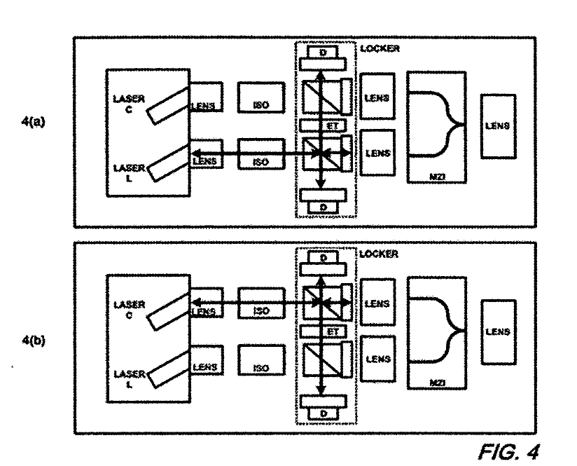

As noted before, an important aspect of our inventive structure is that it permits the sharing of a wavelength locking arrangement among the multiple lasers that comprise the overall module. With simultaneous reference now to FIG. 4(a) and FIG. 4(b) there is shown in block diagram form this important aspect of the present invention.

Shown in FIG. 4(a) and FIG. 4(b) are two laser (chips) which—according to the present invention—may advantageously provide a different output wavelength(s) such that the output wavelength(s) of the overall module is widened. Light output from the individual laser(s) is subsequently provided to a planar-lightwave-circuit (PLC) combiner—in this example, one comprising a Mach-Zehnder Interferometer—which in turn selects the light provided to output lens.

Interconnecting the PLC with the lasers is a set of free space optical components, including lenses (LENS), isolators (ISO) and wavelength locking arrangement having a pair of detectors (D) and an Etalon (ET). As noted earlier, the two detector may be advantageously used with one of the detectors monitoring the power of the laser light while the other can measure the power of the laser light passing through the etalon. The laser light is directed to the detectors by one or more prisms, positioned within the optical path.

As can be appreciated, since only one of the lasers is active at a particular time, the entire locking system may be shared among the lasers, thereby reducing the overall cost of the module. In addition, while we have only shown and discussed the invention including two individual lasers, it should be readily understood that our invention is not so limited, More particularly, it is understood that three, four or more lasers may be advantageously integrated into a common module, thereby permitting even greater overall cost reduction from sharing common components (wavelength locking arrangement, power, control circuitry, etc) while providing a single module that provides even wideroutput wavelength range(s).

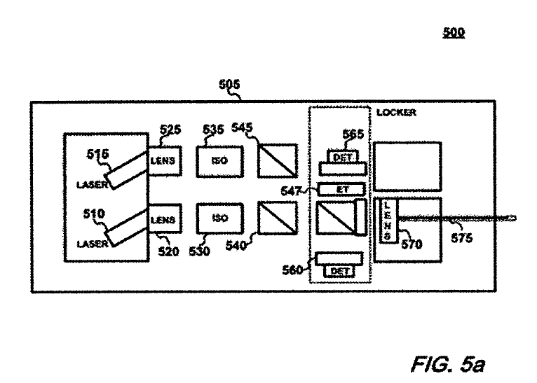

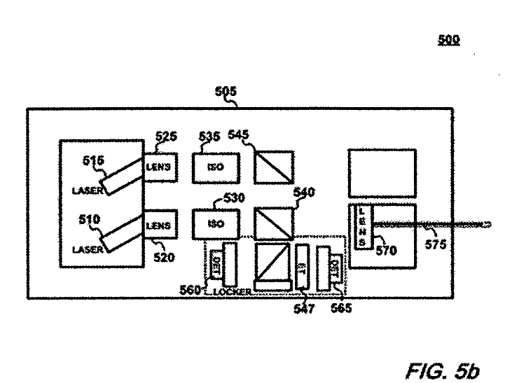

Even further variations in configuration are possible with our inventive principles, as illustrated in FIG. 5(a). Shown in FIG. 5(a) is a configuration in which the multiple lasers 510, 515—in this case a C-band and L-band laser (or others)—share a common wavelength locking arrangement in addition to driving electrical circuitry. The signals from the two lasers may be combined into a single output through free space optics (mirrors and/or beam combining cubes 545). The wavelength locking arrangement includes a pair of detectors 560, 565 which, as before, are used to monitor the laser power and the power through the etalon 547. Light is output through lens 570 and polarization maintaining fiber 575.

A variation on this configuration of FIG. 5(a) is shown in FIG. 5(b). As noted before with our discussion of FIG. 3 and now here as well, the wavelength locking arrangement is positioned such that laser light that is subsequently output does not pass through the locking arrangement. Consequently, lower losses result. Of further advantage to this—or any off-axis configuration or those in which the locking arrangement is not directly in the path of the output laser light—is that any light backscattered from the output fiber coupling or lens—is not coupled directly back into the wavelength locking arrangement.

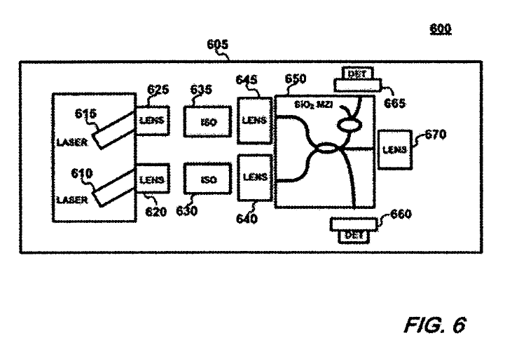

Still further variations in our inventive structure(s) are shown in FIG. 6.

More specifically, the frequency locking system may be integrated onto a common chip 650, which may further include a coupler/switch arrangement. As shown in FIG. 6, the common chip 650 may include a thermo-optic switch and the etalon-type wavelength locking arrangement shown previously, may advantageously be replaced by an integrated frequency filter arrangement, (for example, a Mach-Zehnder filter, ring filter, etc) that provides power-monitoring before and after the filter itself. As before, the pair of detectors 660, 665 monitors the power before and after the filter(s), respectively.

As should now be apparent to those skilled in the art, by packaging a plurality of individual lasers having two or more (possibly) overlapping wavelength regions into a single package, the total wavelength range of the integrated package may advantageously be substantially wider that that provided by a single laser. The co-packaging provides additional opportunity to share driving, power and other electrical circuitry, as well as optical locking mechanisms. Finally, since sharing optical components among the lasers is promoted, new, non-conventional locking mechanisms may be employed since their individual cost is marginalized.

Consequently, such integrated modular packages will lead to simplified provisioning and maintenance by service providers. Still further, reduced inventory resulting from modules exhibiting wider applicability only further enhances their attractiveness.

At this point, while we have discussed and described our invention using some specific examples, those skilled in the art will recognize that our teachings are not so limited. More specifically, while we have described devices and modules that are tunable to potentially any wavelength within the C+L+S band(s) without requiring significant development, it is understood that additional band(s) or wavelengths may be provided by such a common module(s), by appropriate selection(s) of the component laser(s). Accordingly, my invention should be only limited by the scope of the claims attached hereto.

What is claimed is:

1. A laser module comprising:
two or more lasers for generating laser light;
a set of optical components for operating upon the generated laser light prior to its output; and
a locker, for monitoring and locking the characteristics of the laser light to be output;
CHARACTERIZED IN THAT:
the locker is shared between the two or more lasers.

2. The laser module of claim 1:
FURTHER CHARACTERIZED IN THAT:
the locker is not in a direct optical path of the laser light to be output.

3. The laser module of claim 1, wherein said locker comprises:
a splitter, for splitting the generated laser light and directing it into two or more distinct optical paths;
an etalon positioned in one of the distinct optical paths;
a photodetector, positioned in the optical path containing the etalon, for monitoring the wavelength of the generated laser light;
and
a second photodetector, positioned in another optical path, for monitoring the power of the generated laser light.

4. The laser module of claim 3, further comprising a switch/combiner for switching/combining the generated laser light into a single output.

5. The laser module of claim 4 wherein said switch/combiner comprises a Mach-Zehnder Interferometer switch.

6. The laser module of claim 5 wherein said locker is positioned in an optical path optically coupled to a particular path of the switch/combiner, and an output of the module is within a different optical path of the switch/combiner such that the switch/combiner may selectively switch generated laser light between the locker and the output, as desired.

7. The laser module of claim 6 further comprising an integrated planar lightwave circuit (PLC), said PLC including:
the locker; and
an integrated coupler/switch for selectively coupling/switching the generated laser light between the locker and an output as desired.

8. The laser module of claim 7 wherein the PLC is an InP device.

9. The laser module of claim 8 wherein the integrated frequency filter includes a Mach-Zehnder filter.

10. The laser module of claim 9 further comprising one or more lenses, positioned in an optical path between the PLC and an output of the module.

11. The laser module of claim 10 further comprising common driving electrical circuitry, shared among the two or more lasers.
